(19) United States
(12) Patent Application Publication
(10) Pub. No.: US 2013/0264000 A1
(43) Pub. Date: Oct. 10, 2013

(54) Method for Enhancing Flexible Graphite

(71) Applicants: Biing-Jyh Weng, Taoyuan County (TW); Jim-Tarmg Hwang, Taoyuan County (TW)

(72) Inventors: Biing-Jyh Weng, Taoyuan County (TW); Jim-Tarmg Hwang, Taoyuan County (TW)

(73) Assignee: Chung-Shan Institute of Science and Technology, Armaments, Bureau, Ministry of National Defense, Taoyuan County (TW)

(21) Appl. No.: 13/442,161

(22) Filed: Apr. 9, 2012

(51) Int. Cl. B32B 37/10; B32B 37/12

(52) U.S. Cl. 156/77; 156/182

(57) ABSTRACT

A method for enhancing flexible graphite includes the steps of providing two porous sheets of flexible graphite, impregnating the sheets of flexible graphite with adhesive, removing an excessive portion of the adhesive by drying the sheets of flexible graphite, providing a laminate by sandwiching a reinforcing element between the sheets of flexible graphite, and heating and pressing the laminate.

### BACKGROUND OF INVENTION

1. Field of Invention

The present invention relates to a method for enhancing flexible graphite and, more particularly, to a method for enhancing a laminate including sheets of flexible graphite.

2. Related Prior Art

Fuel cells generate electricity and produces heat by reaction of hydrogen in fuel with oxygen in the air based on electrochemistry. Being low in pollution but high in efficiency, fuel cells can be used in generators, vehicles or and portable devices for example. Hence, a lot of efforts have been made in developing and promoting fuel cells.

A bipolar current collector-separator is an important element in a fuel cell because it executes five functions. At first, it separates the fuel gas such as hydrogen from the oxidizer such as oxygen. Secondly, it includes at least one channel in each of two opposite sides for guiding the fuel gas or the oxidizer. Thirdly, it conducts electricity from its cathode to the anode of another fuel cell. Fourthly, it collects currents. Fifthly, it includes piping for circulating coolant for removing heat from the fuel cell.

The bipolar current collector-separator is expected to meet requirements. At first, it must not be penetrable by air. Secondly, it must be electrically conductive. Thirdly, it must stand erosion by acid particularly at high temperature. For example, it must stand erosion by electrolyte in a proton exchange membrane fuel cell for a long period of time. Fourthly, it must be strong so that it can stand bending and heat and can be made small.

A bipolar current collector-separator is often made of graphite. For example, it may be made of synthetic graphite such as IG-15 or POCO. It may alternatively be made of a composite including carbon powder and thermosetting or thermoplastic polymer. Such composites can be found in U.S. Pat. Nos. 4,301,222, 4,214,969, 4,197,178, 4,339,322 and 4,214,969.

The above-discussed materials are however brittle, expensive, heavy, penetrable, or poor in maneuverability or conductivity. An expensive material renders a product expensive and acceptable in the market. A brittle or penetrable material renders it difficult to make a thin bipolar current collector-separator that would renders a fuel cell small in size or high in energy density.

As disclosed in U.S. Pat. No. 6,706,400 B2, Flexible Graphite Article and Method of Manufacture, vermicular graphite is added with ceramic or graphite fibers to increase evenness after it is rolled. Then, the graphite is rolled and hence turned into flexible graphite. The flexible graphite is sprayed with glue, dried, and made with channels, thus providing a bipolar current collector-separator. It is however difficult for the flexible graphite to evenly absorb the glue sprayed onto it particularly when it is large and thick in which de-lamination would occur. Moreover, it is weaker because the flexible graphite is not added with any reinforcing material.

The present invention is therefore intended to obviate or at least alleviate the problems encountered in prior art.

### SUMMARY OF INVENTION

It is the primary objective of the present invention to provide a method for enhancing flexible graphite.

To achieve the foregoing objective, the method includes the steps of providing two porous sheets of flexible graphite, impregnating the sheets of flexible graphite with adhesive, removing an excessive portion of the adhesive by drying the sheets of flexible graphite, providing a laminate by sandwiching a reinforcing element between the sheets of flexible graphite, and heating and pressing the laminate.

In an aspect, the step of providing the porous sheets of flexible graphite includes the steps of heating and turning expandable graphite powder into vermicular graphite powder, and pressing and turning the vermicular graphite into the porous sheets of flexible graphite.

In another aspect, the step of impregnating the sheets of flexible graphite includes the step of placing the sheets of flexible graphite in a vacuum impregnation device.

In another aspect, the adhesive is thermosetting resin such as polyimide, silicone, epoxy and phenolic resin.

In another aspect, the adhesive includes less than 90% of the thermosetting resin.

In another aspect, the step of drying the sheets of flexible graphite includes the step of placing the sheets of flexible graphite in a vacuum drying device.

In another aspect, the reinforcing element is a net of metal, a fabric of glass fibers, a fabric of carbon fibers or a fabric of graphite fibers.

In another aspect, the step of heating and pressing the laminate includes the step of providing two molding plates for pressing the laminate.

In another aspect, each of the molding plates includes at least one rib formed thereon for making a groove in the laminate.

In another aspect, the step of providing the laminate includes the steps of providing an additional number of sheets of flexible graphite, providing an identical number of reinforcing elements, and sandwiching each of the reinforcing elements between two adjacent ones of the sheets of flexible graphite.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawing wherein:

FIG. 1 is a flow chart of a method for reinforcing flexible graphite according to the preferred embodiment of the present invention.

### DETAILED DESCRIPTION OF PREFERRED EMBODIMENT

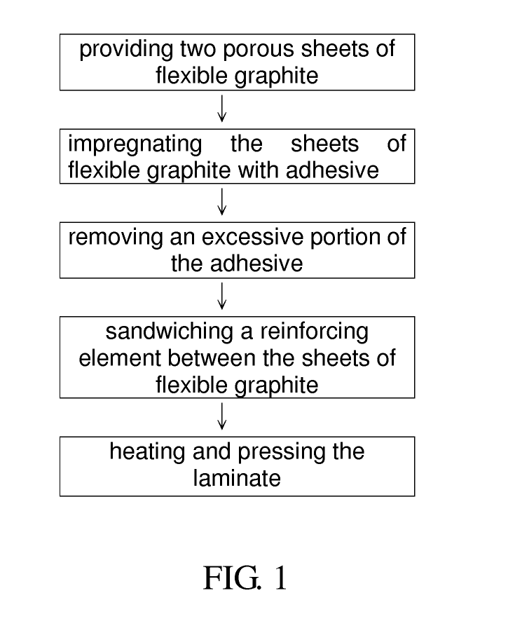

Referring to FIG. 1, there is shown a method for reinforcing flexible graphite according to the preferred embodiment of the present invention. The flexible graphite may be used in a bipolar current collector-separator.

At first, expandable graphite powder is heated and hence turned into vermicular graphite powder.

Secondly, the vermicular graphite is pressed and hence turned into two porous sheets of flexible graphite.

Thirdly, the sheets of flexible graphite and a reinforcing element are placed in a vacuum impregnation device so that the sheets of flexible graphite and the reinforcing element are impregnated with adhesive. The reinforcing element may be a net of metal such as 316 stainless steel and a fabric that includes glass, carbon or graphite fibers. The adhesive may be thermosetting resin such as polyimide, silicone, epoxy and phenolic resin. The adhesive includes less than 90% of the thermosetting resin.

The reinforcing element is impregnated with adhesive as discussed above. Alternatively, the reinforcing element may not be impregnated with any adhesive.

Fourthly, the sheets of flexible graphite and the reinforcing element are dried in a drying device such as an oven. Some of the adhesive is dried and hence cured while the other adhesive is recycled.

Fifthly, the reinforcing element is sandwiched between the sheets of flexible graphite, thus providing a laminate. The laminate is inexpensive and highly electrically conductive and can hence be used as a graphite-based composite panel or a mono-polar or bipolar current collector-separator in a fuel cell or a vanadium cell.

In an exemplary process, at first, expandable graphite powder is heated and hence turned into vermicular graphite powder.

Secondly, 10 grams of the vermicular graphite is pressed and hence turned into two 20×40×0.66 cm porous sheets of flexible graphite.

Thirdly, the sheets of flexible graphite and a 316 stainless steel net are placed in a vacuum impregnation device so that the sheets of flexible graphite and the reinforcing element are impregnated with a solution of epoxy. The solution is made by dissolving epoxy in acetone at a ratio of 1:4. The mixture of epoxy includes Epoxy Model Nos. 507 and 906 and Catalyst Dy061 at a ratio of 100:80:1.

Fourthly, excessive solution of epoxy is removed before the sheets of flexible graphite and the reinforcing element are dried for 65° C. for 8 hours and processed with vacuum at 90° C. for 5 hours.

Fifthly, the reinforcing element is sandwiched between the sheets of flexible graphite, thus providing a laminate. The laminate is heated at 130° C. and pressed at 70 kg/cm² so that it is formed into a flat specimen. The flat specimen is pressed by two molding plates so that there is at least one groove made in each of two opposite sides of the flat specimen.

The size of the flat specimen is 9.4×2.9×60 (mm). The density of the specimen is 1.55 g/cm³. The resistivity of the flat specimen is measured to be 6.8×10⁻⁴ Ω-cm by a A X-124N, 1 KHz, mΩ milliohm meter.

For comparison, a specimen of IG15 graphite is provided. The size of the specimen of IG15 graphite is 10×5×60 (mm). The density of the specimen of IG15 graphite is 1.91 g/cm³. The resistivity of the specimen of IG15 graphite is 7.9×10⁻⁴ Ω-cm.

The flat specimen of flexible graphite of the present invention is compared with a flat specimen made according to U.S. Pat. No. 6,706,400. The results of the comparison are listed in Table 1.

TABLE 1

| | U.S. Pat. No. 6,706,400 B2 | Present Invention |
|---|---|---|
| Forming | Rolling | Pressing by Molds |
| Adhesive | 1. Spray | 1. Vacuum Impregnation |
| | 2. non-uniform Distribution | 2. Even Distribution |
| | (Particular So with Thick | (Particular So with Thick |
| | Specimen) | Specimen) |
| | 3. Much De-lamination | 3. Less De-lamination |
| Z-axis | Enhanced by Adding Ceramic | Not Necessary |
| Conductivity | or Graphite fibers to | |
| Reinforcing | No | 1. Yes |
| Element | | 2. Strong Enough for |
| | | Large Size |
| Forming | 1. non-uniform Density | 1. Even Density |
| | 2. non-uniform Strength | 2. Even Strength |

The laminate of the present invention is strong and can hence be used as a large graphite-based composite panel or a mono-polar or bipolar current collector-separator in a fuel cell or a vanadium cell. The laminate of the present invention can be made with a size of 1×1 (m) and even density and strength at a high yield.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for enhancing flexible graphite including the steps of:
providing two porous sheets of flexible graphite;
impregnating the sheets of flexible graphite with adhesive;
removing an excessive portion of the adhesive by drying the sheets of flexible graphite;
providing a laminate by sandwiching a reinforcing element between the sheets of flexible graphite; and
heating and pressing the laminate.

2. The method according to claim 1, wherein the step of providing the porous sheets of flexible graphite includes the steps of:
heating and turning expandable graphite powder into vermicular graphite powder; and
pressing and turning the vermicular graphite into the porous sheets of flexible graphite.

3. The method according to claim 1, wherein the step of impregnating the sheets of flexible graphite includes the step of placing the sheets of flexible graphite in a vacuum impregnation device.

4. The method according to claim 3, wherein the adhesive is thermosetting resin selected from the group consisting of polyimide, silicone, epoxy and phenolic resin.

5. The method according to claim 4, wherein the adhesive includes less than 90% of the thermosetting resin.

6. The method according to claim 1, wherein the step of drying the sheets of flexible graphite includes the step of placing the sheets of flexible graphite in a vacuum drying device.

7. The method according to claim 1, wherein the reinforcing element is selected from the group consisting of a net of metal, a fabric of glass fibers, a fabric of carbon fibers and a fabric of graphite fibers.

8. The method according to claim 1, wherein the step of heating and pressing the laminate includes the step of providing two molding plates for pressing the laminate.

9. The method according to claim 8, wherein each of the molding plates includes at least one rib formed thereon for making a groove in the laminate.

10. The method according to claim 1, the step of providing the laminate includes the steps of:
providing an additional number of sheets of flexible graphite;
providing an identical number of reinforcing elements; and
sandwiching each of the reinforcing elements between two adjacent ones of the sheets of flexible graphite.
